(19) United States
(12) Patent Application Publication
(10) Pub. No.: US 2020/0082460 A1
(43) Pub. Date: Mar. 12, 2020

(54) PREPARATORY SESSION FOR A SUBSEQUENT TRANSACTION

(71) Applicant: Apple Inc., Cupertino, CA (US)

(72) Inventors: Sonal Patidar, San Jose, CA (US); Elton Kong, Mountain View, CA (US); Filip Krsmanovic, Palo Alto, CA (US); Douglas Park, Palo Alto, CA (US); Narayan Koteshwar Rajagopal, Sunnyvale, CA (US); Sonny La Motte, Tucson, AZ (US); Yann Cheri, Santa Clara, CA (US)

(21) Appl. No.: 16/128,412

(22) Filed: Sep. 11, 2018

(51) Int. Cl. G06Q 30/06; G06Q 40/02; G06Q 20/12

(52) U.S. Cl. CPC G06Q 30/0635; G06Q 20/12; G06Q 40/025

(57) ABSTRACT

The present technology addresses the need in the art for a technology that can allow a customer to prepare for a transaction to be performed later. The present technology permits a customer to carry out such preparatory actions in a preparatory session that can be saved and accessed in a later transaction session after the item is available for purchase to make the transaction session shorter and more efficient.

### TECHNICAL FIELD

The present technology pertains to limited supply transactions, and more specifically to conducting a preparatory session to prepare to conduct a later transaction session.

### BACKGROUND

Some transactions involve goods, services, or tickets for which there is such demand that customers have historically waited in line outside stores or ticket offices over night so that they can be early enough in line to have a chance to acquire the desired item as soon as it goes on sale. Now that many of these transactions can happen over the Internet, customers log on to a website just when the item goes on sale and find themselves racing to get through the transaction while inventory remains. Customers face slow servers that sometimes crash. Anything that can make the transaction go smoother will enhance the customer's chances at acquiring the desired item.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example of a system in accordance with some embodiments of the present technology;

FIG. 2A, FIG. 2B, FIG. 2C, and FIG. 2D illustrate an example method for conducting a preparatory session in accordance with some embodiments of the present technology;

FIG. 3A, FIG. 3B, and FIG. 3C illustrate and example method for conducting a transaction session that follows a preparatory session in accordance with some embodiments of the present technology;

FIG. 4A, FIG. 4B, FIG. 4C, FIG. 4D, FIG. 4E, FIG. 4F, FIG. 4G, and FIG. 4H illustrate example preparatory-transaction pages displayed by a computing device for conducting a preparatory session in accordance with some embodiments of the present technology:

FIG. 5A, FIG. 5B, and FIG. 5C illustrate example pages displayed by a computing device for conducting a transaction session that follows a preparatory session in accordance with some embodiments of the present technology;

FIG. 6 illustrates an example method of conducting a transaction including a preparatory session and a transaction session in accordance with some embodiments of the present technology; and

FIG. 7 shows an example of a system for implementing certain aspects of the present technology.

### DETAILED DESCRIPTION

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

The disclosed technology addresses the need in the art for a technology that can allow a customer to prepare for a transaction to be performed later. For example, when an item (e.g., a new mobile phone) is announced, the announcement is accompanied by a date in which the item goes on sale. That date might be a pre-order date, or the date customer's can actually receive the item. For some items, predicted demand can be so high that it is not expected that all customers will be able to purchase the item on the first day the item goes on sale. Some customer's may want to prepare for their orders in any way possible to speed up the transaction and improve the customer's chances that they successfully purchase the item. For example, a customer might want to choose the desired item and any available options ahead of time. A customer might want to enter payment information, and/or be preapproved for the transaction. In some cases, if the item will be paid for by a loan or a lease, the customer might want to fill out any forms, or by pre-approved for the loan or lease. The present technology permits a customer to carry out such preparatory actions in a preparatory session that can be saved and accessed in a later transaction session after the item is available for purchase to make the transaction session shorter and more efficient, and thus increase the likelihood of successfully acquiring the item.

The disclosed technology also addresses a need from the point of view of the server(s) that will be handling the transactions. Often when demand for items are high, e-commerce servers can become overloaded, run slow, drop sessions, and/or crash. Such occurrences create frustration amongst customers, and might even cause sales to be missed if a server is down for a period of time. Accordingly, the preparatory sessions addressed herein can spread out demand for server resources, and make the transaction sessions more efficient.

Some aspects of the present technology involve the gathering and use of data available from various sources to improve the delivery to users of a preparatory session or a transaction session. The present disclosure contemplates that in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, social security numbers, or any other identifying or personal information.

The present disclosure recognizes that the use of such personal information data, in the present technology, can be used to the benefit of users. For example, the personal information data can be used to pre-populate loan forms and prepare for transaction sessions. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of pre-populating loan forms, the present technology can be configured to allow users to select to “opt in” or “opt out” of participation in the collection of personal information data during registration for services or anytime thereafter. In another example, users can select not to provide information necessary to automatically retrieve loan form data. In addition to providing “opt in” and “opt out” options, the present disclosure contemplates providing notifications relating to the access or use of personal information.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

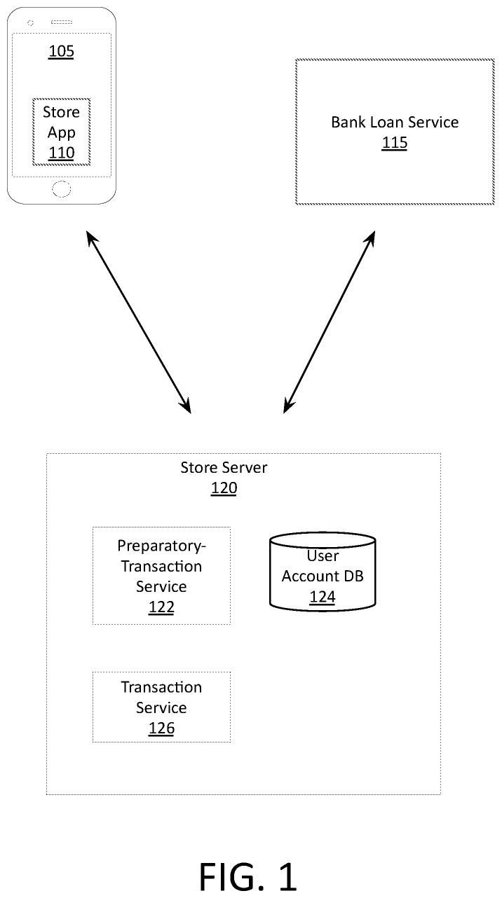

FIG. 1 illustrates an example system embodiment in which it can be useful to utilize a preparatory session prior to a transaction session. For explanatory purposes the present technology will be explained in the context of an item announcement (e.g., a new iPhone will be released) where the item will go on sale (for pre-order or the item is available at the time of purchase) and be purchased at a later date. However, the present technology can be useful in any context in which a preparatory session could be useful prior to a later transaction session.

As illustrated in FIG. 1 computing device 105 can have store app 110 installed thereon. After an item announcement, but before the item is available for purchase, a user can operate computing device 105 to interact with store app 110 to send communications to, and receive communications from, store server 120 to conduct a preparatory session with preparatory-transaction service 122. As will be described herein a preparatory session can be used to create preparatory-transaction data by selecting the item that is not yet available for purchase, and providing payment information. Preparatory-transaction service 122 can save the preparatory-transaction data in association with a user account in user account database 124.

In some embodiments, preparatory-transaction service 122 can determine that the user account logged into computing device 105 used a loan to pay for one or more past purchases, and should the user desire to use a loan to pay for the item now, preparatory-transaction service 122 can communicate with bank loan service 115 to retrieve loan details to be used to pre-populate a new loan form, and to apply for the new loan. Any loan approval can be stored with the preparatory-transaction data in association with a user account in user account database 124.

In some embodiments, such as for example a purchase of an iPhone, user accounts can participate in a financed, yearly upgrade program. Under such a program, users can finance the purchase of an iPhone using an installment loan provided by bank loan service 115. Then, after a set amount of time passes (e.g., 8 months or 1 year, etc.), the user can opt to get a new iPhone by taking out a new installment loan (that will supersede the previous installment loan), and returning the older iPhone. When a user account shows that the user is participating in the yearly upgrade program, preparatory-transaction service 122 can communicate with bank loan service 115 to determine whether the user account is eligible to upgrade at the present time, and can retrieve loan details to be used to pre-populate a new loan form, and apply for the new loan. Any loan approval can be stored with the preparatory-transaction data in association with a user account in user account database 124.

Later when the item is available for purchase, the user can operate computing device 105 to interact with store app 110 to interact with store server 120 to conduct a transaction session by retrieving the preparatory-transaction data stored in association with the user account in user account database 124, and using the preparatory-transaction data to resume the transaction with transaction service 126 at the point of the transaction last saved in association with the user account from the preparatory session. In some embodiments, the transaction will be resumed in the transaction session at the checkout stage of the transaction, but in some embodiments, the user might not have completed all steps in the transaction that are required to complete the transaction and the transaction can resume in the transaction session at the point of the transaction last saved in association with the user account during the prior preparatory session.

Additionally, even when the user has completed the transaction during the preparatory session to the point of checkout, the user can return to previously completed data during the transaction session, if desired.

While FIG. 1 illustrates computing device 105 in a mobile device form factor, the present technology can also be carried out by any computing device. Additionally, while FIG. 1 illustrates store app 110 for interacting with store server 120, the present technology can be carried out using any capable software, such as a web browser or third party application, to access and communicate with store server 120. Additionally while preparatory-transaction service 122 and transaction service 126 are shown as separate entities, it will be appreciated that these entities can be combined into a single service that performs the functions attributed to preparatory-transaction service 122 and transaction service 126.

Bank loan service 115 can be a separate entity from store server 120 where store server 120 requests information and provides information using application programming interfaces (APIs) provided by bank loan service 115, or bank loan service 115 can be a combined entity with store sever 120.

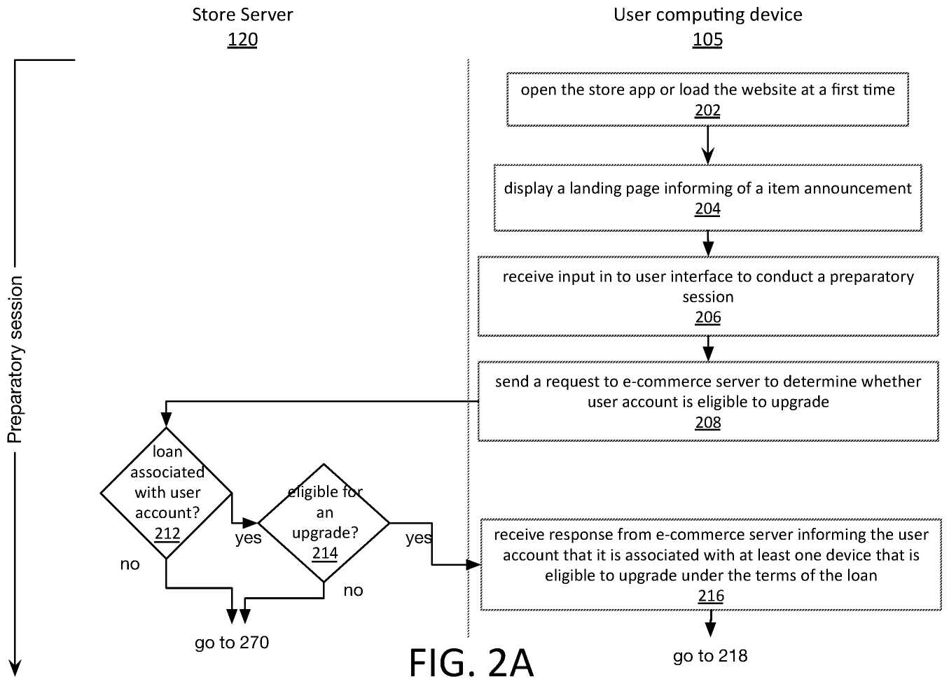

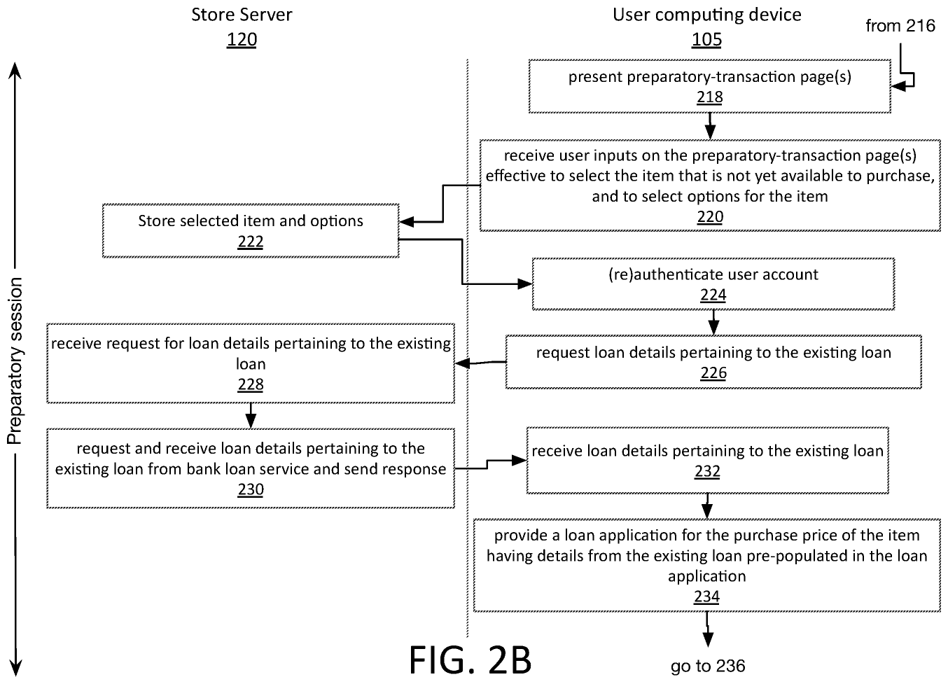

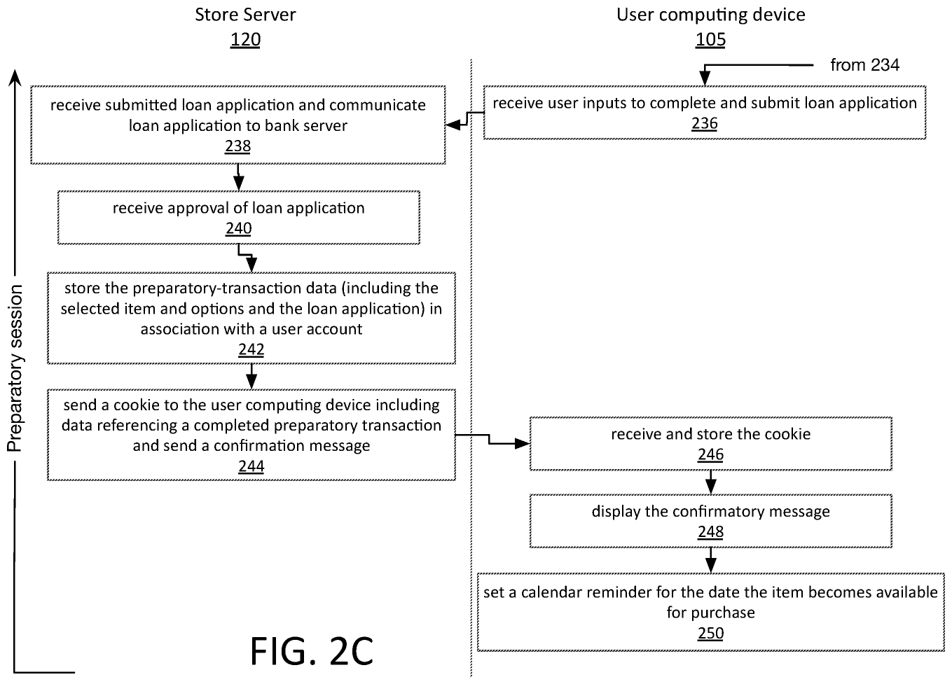

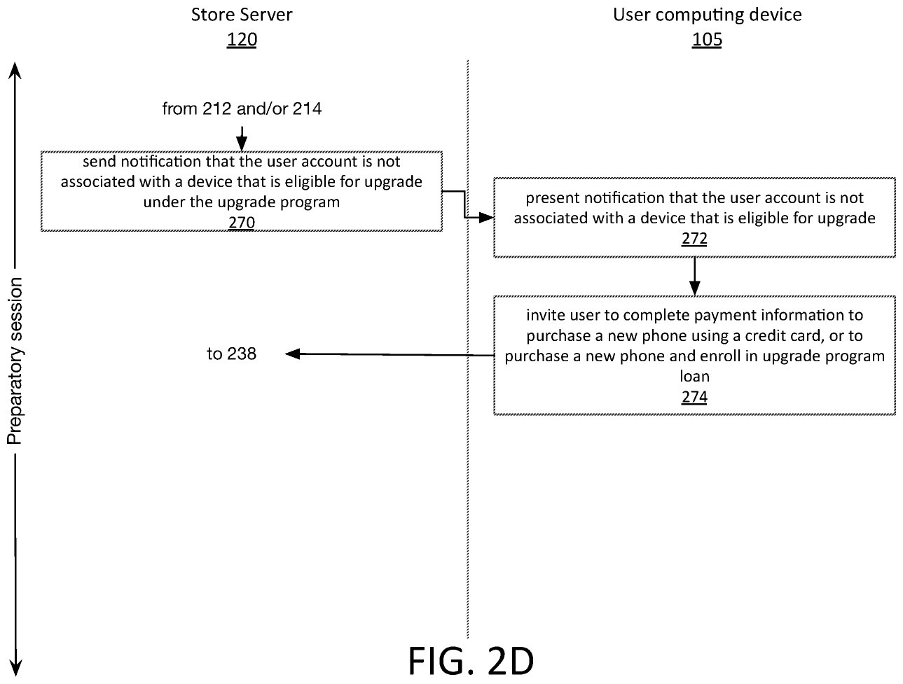

FIGS. 2A, 2B, 2C, and 2D illustrate pages displayed by store app 110 on mobile device in conducting an example preparatory session in accordance with some embodiments of the present technology. As above, the description will continue to reference an example use case for the present technology where a new model of iPhone has been announced that will be available for purchase at a later date. To more completely describe certain features of the present technology, the following description will be described in the context of an upgrade from the user's current iPhone to the new model of iPhone using an upgrade program wherein a user utilizes an installment loan to participate in the upgrade program. While the present technology is described in such a context, it will be appreciated by those of ordinary skill in the art that some or all portions of the described technology can be applied to other contexts, and the technology is generally applicable to any transaction where it is beneficial to conduct a preparatory session prior to the transaction session.

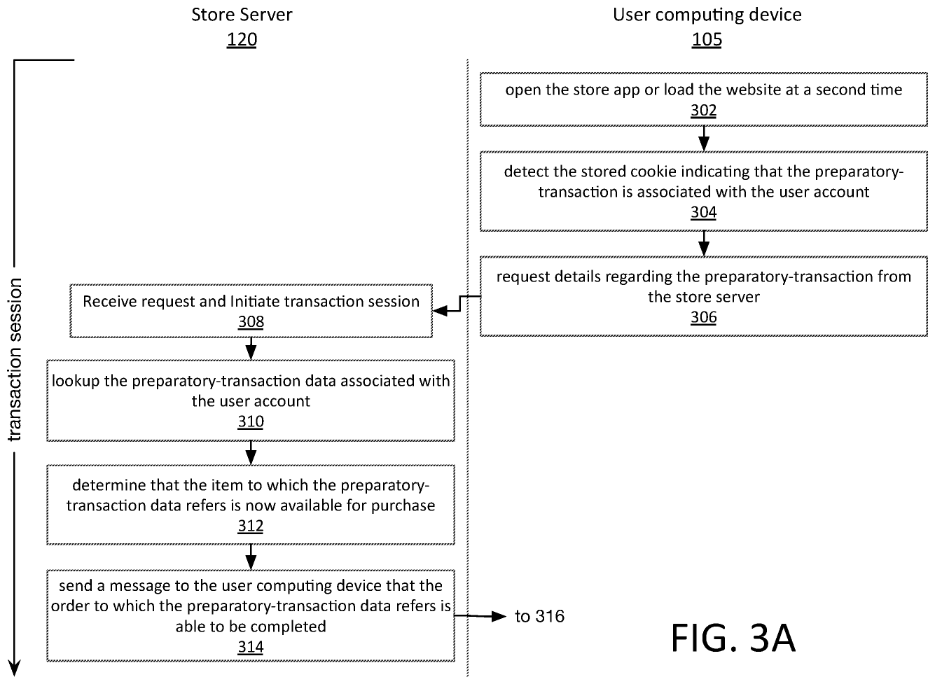

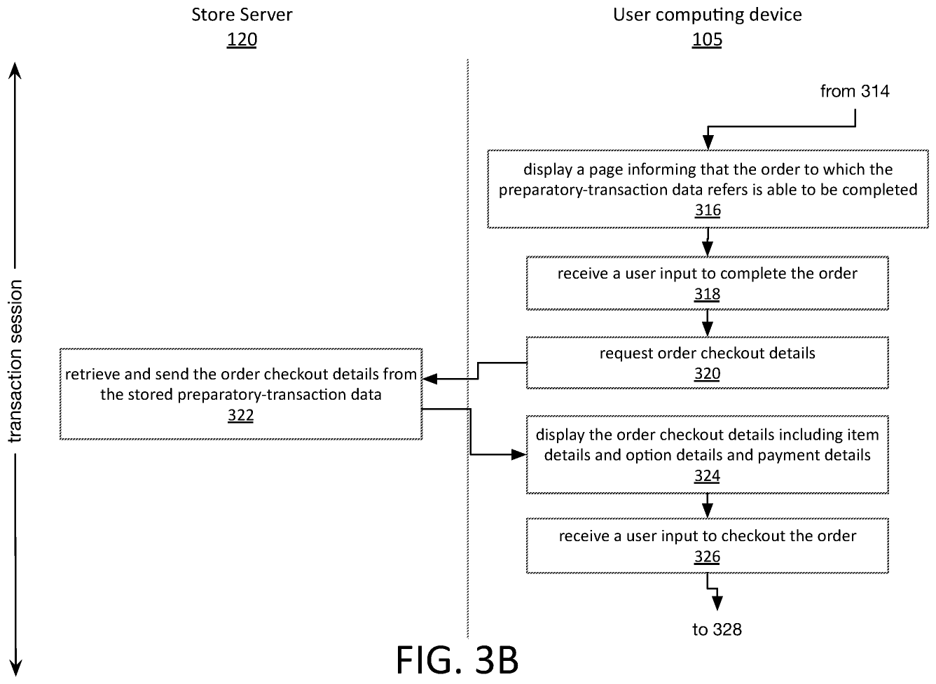

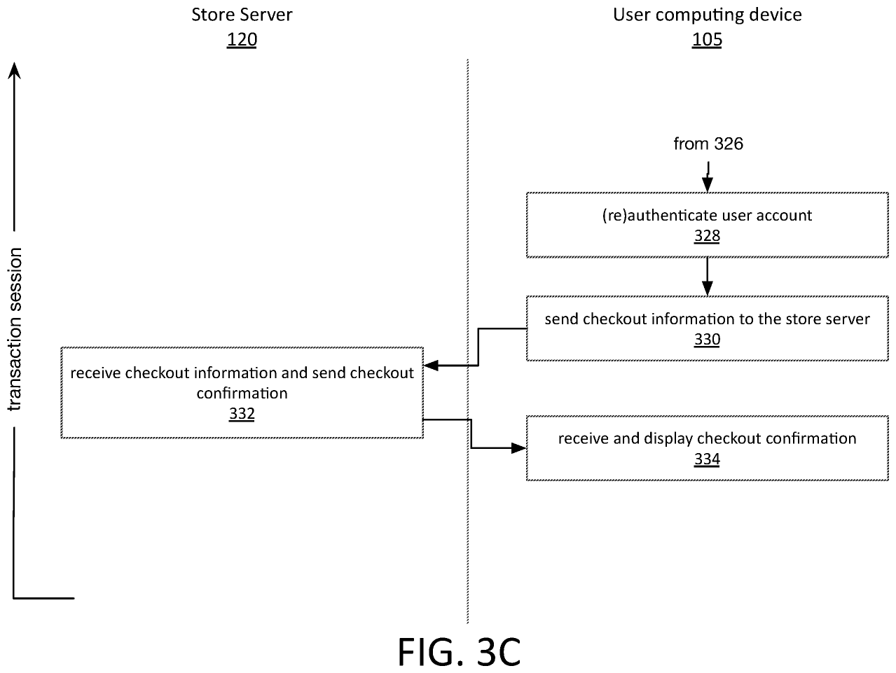

A preparatory session begins when a user operating computing device 105 opens (202) store app 110 or loads a store website at a first time. The first time is used to indicate that the preparatory session occurs at a time prior to a transaction session (addressed in FIGS. 3A, 3B, and 3C). In most cases, the first time is on a different date than the time of the transaction session, or at minimum, the first time is a time prior to the initiation of the transaction session. In some embodiments, a transaction session can also refer to separately initiated sessions with store server 120.

Computing device 105 can communicate with store server 120, and can retrieve and display (204) a landing page informing a user of an item announcement (e.g., announcement of a new model of iPhone). While the item is announced, in some embodiments, the item is not yet available to purchase.

However, the landing page may provide an option to prepare to purchase the item, and computing device 105 can receive (206) an input selecting the option to prepare to purchase the item in a preparatory session on store server 120. In response, computing device 105 can send (208) a request to preparatory-transaction service 122 on store server 120 to determine whether a user account logged into computing device 105 has any devices eligible for upgrade under the terms of an upgrade program.

Preparatory-transaction service 122 can receive the request and can determine (212) whether the user account is associated with any loans in user account database 124. When it is determined that the user account is associated with a loan in user account database 124, preparatory-transaction service 122 can determine whether (214) a device secured by the loan is eligible for an upgrade under the terms of the loan. When the user account is associated with a device that is eligible for upgrade under the terms of the loan, store server 120 can send a response that is received (216) by computing device 105 informing the user account that it is associated with at least one device that is eligible to upgrade under the terms of the loan.

When it is determined (212) that user account is not associated with a device participating in the loan upgrade program, or it is determined (214) that the device participating in the loan upgrade program is not eligible for upgrade under the terms of the loan, preparatory-transaction service 122 can send (270) a notification that the user account is not associated with a device that is eligible for upgrade under the upgrade program as illustrated in FIG. 2D, addressed below.

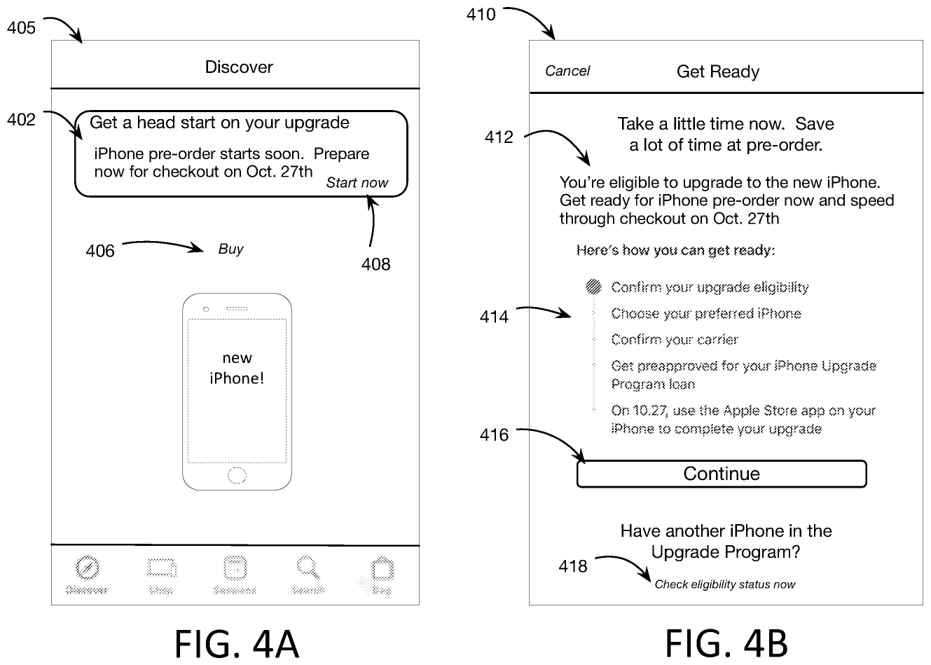

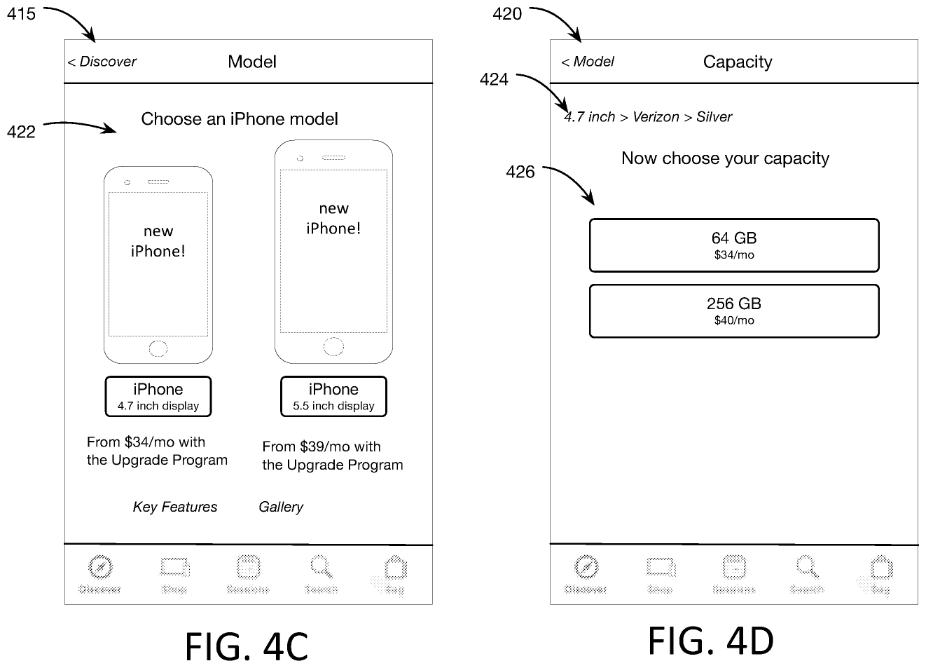

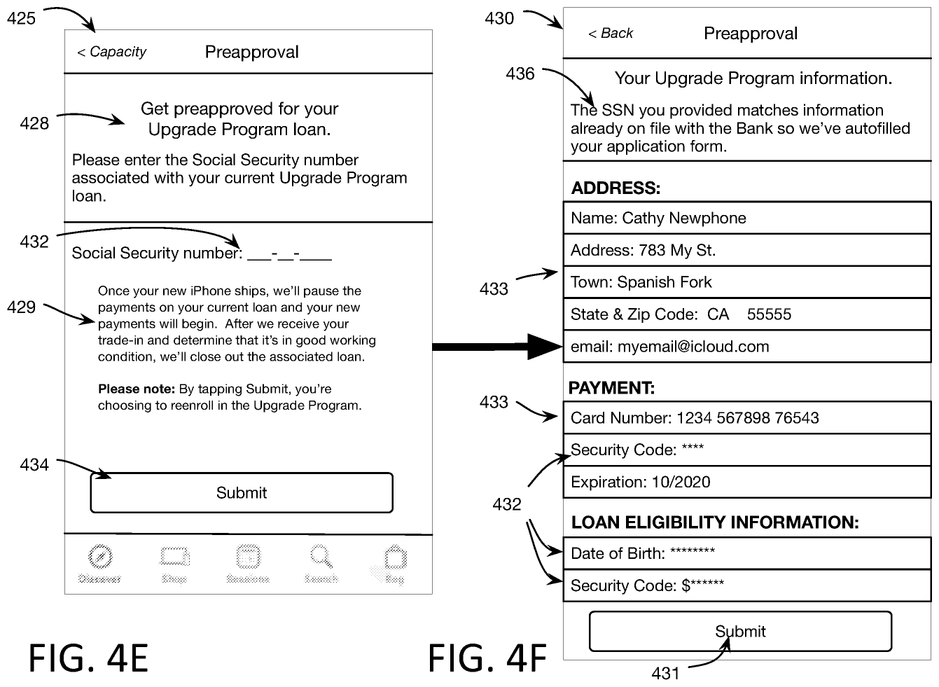

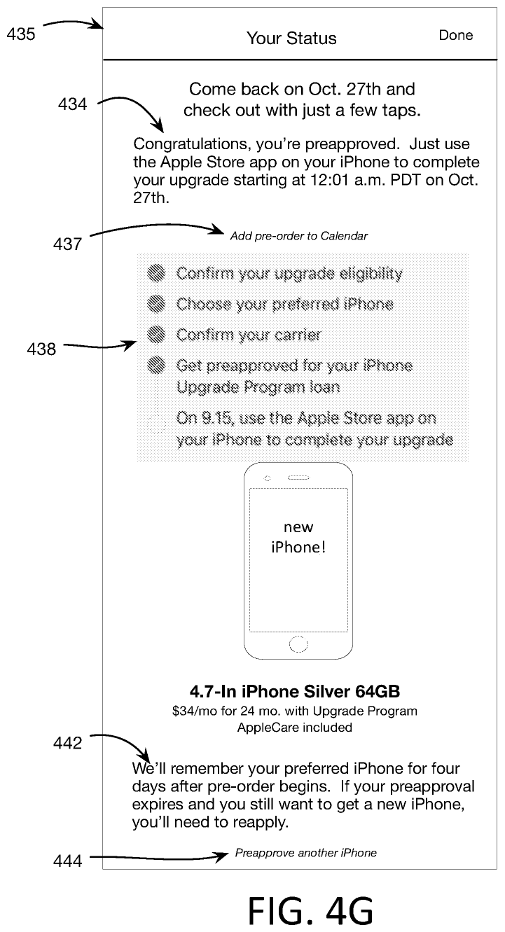

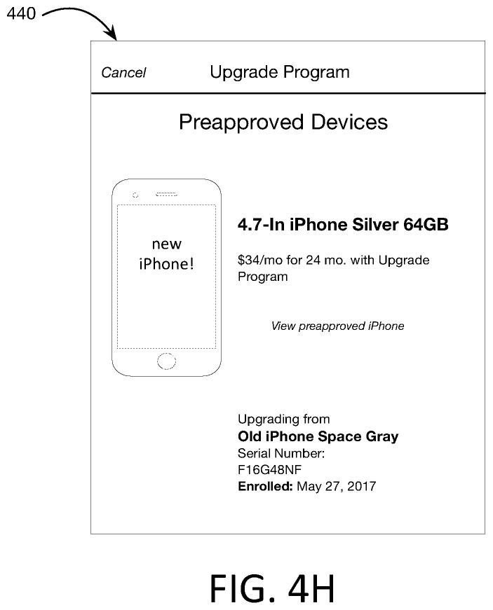

Continuing to FIG. 2B, after computing device 105 receives (216) the response from server 120, computing device 105 can present (218) one or more preparatory-purchase page(s) as illustrated in FIGS. 4A-4H. The preparatory-purchase page(s) can provide information and user interface buttons or fields for receiving selections of an item that is not yet available to purchase, options for the item, shipping details, payment details, etc. Computing device 105 can receive (220) user inputs on the preparatory-purchase page(s) effective to select the item that is not yet available to purchase, and select options for that item using the user interface buttons or fields on the preparatory-purchase page(s).

After the user, using computing device 105, has entered information and selected various options presented on each preparatory-purchase page, computing device 105 can send the entered information to store server 120 which can store (222) the selected items and options. In the example user interface is shown in FIGS. 4A-4D, computing device 105 can present a series of interfaces for initiating a preparatory session (FIG. 4A), confirming upgrade eligibility (FIG. 4B), choosing a model of the item (FIG. 4C), and choosing options related to the item (FIG. 4D), before applying for a loan (or entering other payment options) as illustrated in FIGS. 4F-4G. In accordance with the user interface is shown in FIGS. 4C and 4D, as the user operates computing device 105 to select the item and options, store server 120 can store (222) the selected item and options in association with the user account in user account database 124.

After the selection of the item and options, store server 120 can prompt the user of computing device 105 to authenticate the user account. The user operating computing device 105 can provide the credential and authenticate (224) the user account with store server 120.

In some embodiments, the authentication performed at step 224 can be the first authentication performed with store server 120. In such embodiments, the previous steps of the preparatory session can take place by receiving only the user account identifier for the user account currently logged in to computing device 105. This level of identification/authentication can be deemed sufficient, in some embodiments, since in most instances and user will have had to unlock computing device 105 prior to operating the device to participate in the preparatory session. Additionally, to this point in the preparatory session, the user account has not attempted to access any important confidential information. However, going forward the user account may need to access confidential information, such as details pertaining to an existing loan, and may take steps toward committing to by the item that is not yet available to purchase.

After computing device 105 has authenticated (224) the user account with store server 120, computing device 105 can request (226) loan details pertaining to any existing loan associated with the user account. Store server 120 can receive (228) the request for loan details pertaining to the existing loan, and can in turn request (230) the loan details from bank loan service 115 using an application programming interface (API) provided by banking service 115. Bank loan service 115 can send the loan details which are received (230) by store server 120 and are sent (230) to computing device 105.

In some embodiments, the details pertaining to the existing loan can be used to provide (234) a loan application for the purchase price of the item having details from the existing loan pre-populated in the loan application. In some embodiments, as introduced above, loan application can be associated with an upgrade program, where each upgrade includes an application for a new loan that supersedes the previous loan.

Continuing to FIG. 2C, once computing device 105 has displayed the loan application with details from an existing loan pre-populated into the loan application form, computing device 105 can receive (236) user inputs effective to complete and submit loan application.

Store server 120 can receive (238) the submitted loan application and communicate the loan application to bank loan service 115 using an application programming interface (API) provided by bank loan service 115. Bank loan service 115 can make a determination regarding the approval of the loan, and assuming the loan has been approved, preparatory-transaction service 122 can receive (240) a notification regarding the approval of the loan application along with information identifying loan. Store e-commerce server 120 can store (242) the preparatory-transaction data including the selected item that is not yet available for purchase and options pertaining to the selected item, and the loan application approval in association with the user account in user account database 124. Preparatory-transaction service 122 can send (244) a cookie to the computing device 105 that includes data referencing the completed preparatory transaction and can send a confirmation message. In some embodiments, the cookie references the fact that a preparatory transaction has been completed, but does not include any specifics of the preparatory transaction. While steps 244 and subsequent steps in this and other figures refer to the use of a cookie, persons of ordinary skill in the art will appreciate that the present technology is not limited to use of a cookie and other mechanisms useful for recording session or state information (e.g., such as a token, or saved session data, etc.) can be used to achieve the same or similar functions.

Computing device 105 can receive and store (246) the cookie, and display (248) the confirmatory message in store app 110 (or a webpage). The confirmatory message (as illustrated in FIG. 4H) can indicate a time in which the item can become available to purchase, and at that time it will be possible to complete the transaction. In some embodiments, the confirmatory message can also include an option to set a calendar reminder for the date the item becomes available to purchase, and when this option is selected, computing device 105 can set (250) the calendar reminder. In some embodiments, store server 120 can additionally, or alternatively, send an email reminder, or a message, or other notification for presentation on computing device 105 to remind the user to return to the store app 110 or website to conduct the transaction session described below.

In some embodiments, the item for which the preparatory session was conducted can be associated with multiple user accounts. For example, in some embodiments, a user account of a parent or guardian may be the user account responsible for purchasing the item, however, a dependent's user account will be the user account operating the item (e.g. an upgraded iPhone). In such embodiments, the dependent's item will appear as an item available for upgrade associated with the parent's user account in the presented (218) preparatory-purchase page(s) display by computing device 105.

When the parent user account conducts a preparatory session to upgrade the dependent's iPhone the dependent's user account can receive (246) the cookie including a reference to the completed preparatory transaction so that both the user account paying for the item, and the user account using the item can be reminded of the completed preparatory session.

As noted above, when the user account is not associated with a device that is eligible for upgrade under the upgrade program as determined in step 212 and/or step 214, preparatory-transaction service 122 can send (270) a notification informing the user of this fact. Store app 110 can present (272) a notification on computing device 105 informing the user that the user account is not associated with the device that is eligible for upgrade, and can present a notification and selectable options that invites (274) the user to either purchase a new iPhone using a credit card, or to purchase the iPhone using a loan. In some embodiments, the loan can be part of the upgrade program, so that when the user enrolls in the upgrade program, the user will be eligible to upgrade under the terms of the upgrade program next year. When the user elects to move forward with the preparatory transaction, the method progresses to step 238. While step 238 and the other steps illustrated in FIG. 2C reflect steps involving a loan application, they are equally applicable to receiving and saving any payment options in preparation for purchasing a new iPhone when it is later available for purchase or pre-order.

As illustrated in FIG. 3A, at a second, later time, when the item that was the subject of the preparatory session is available for purchase, the user operating computing device 105 can open (302) store app 110 or load the website. Store app 110 on computing device 105 can detect (304) the stored cookie indicating that a preparatory transaction is associated with the user account. Store app 110 can then request (306) details regarding the preparatory transaction from transaction service 126 at store server 120.

Store app 110 can receive (308) the request for details regarding the preparatory transaction and look up (310) the preparatory-transaction data associated with the user account in user account database 124. After retrieving the preparatory-transaction data, transaction service 126 can determine that the transaction to which the preparatory-transaction data refers is able to be completed and can send a message (314) to the computing device that the item can be purchased.

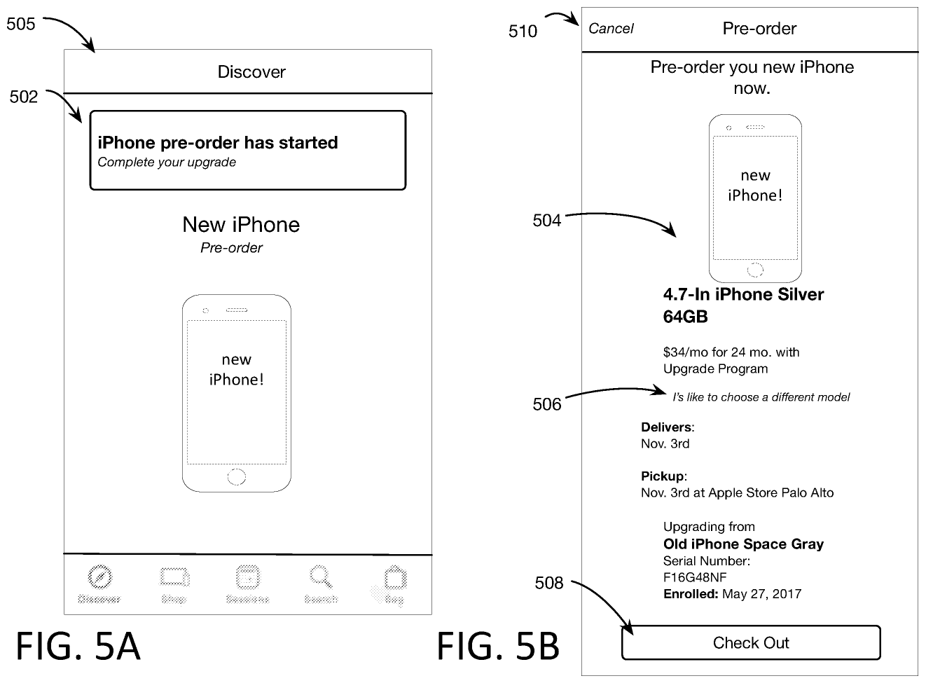

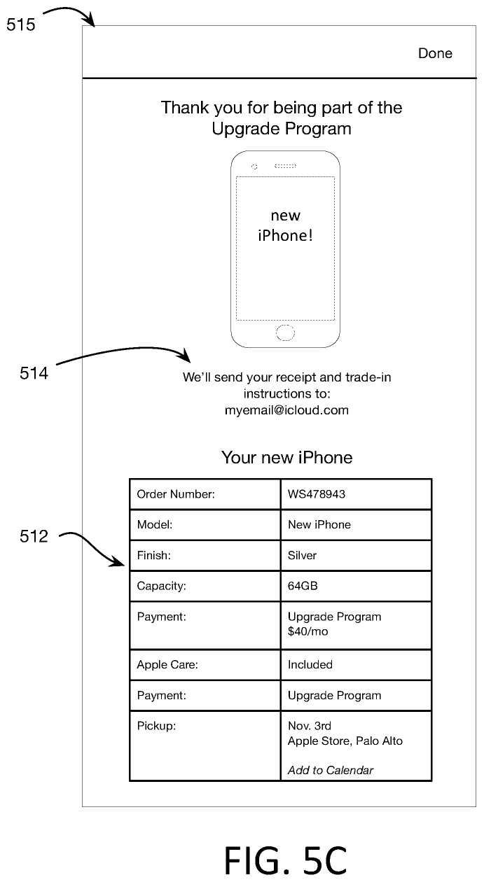

As illustrated in FIG. 3B, computing device 105 can display (316) a page informing the user that the order to which the preparatory-transaction data refers is able to be completed. The page can include selectable user interface elements (see FIG. 5A & FIG. 5B) to receive (318) user inputs from the user operating computing device 105 to indicate that the user desires to complete the order.

Store app 110 can request (320) checkout details from transaction service 126, and store server 120 can retrieve (322) and send the order checkout details from the stored preparatory transaction data stored in association with the user account at user account database 124.

Using this data computing device 105 can display (324) order checkout details including item details, option details, and payment details. After reviewing the order checkout details, the user can provide and computing device 105 can receive (326) user input to check out the order.

As illustrated in FIG. 3C, store app 110 can then authenticate (328) the user account, and can send (330) check out information to transaction service 126 on store server 120. Transaction service 126 can receive (332) the checkout information (including for example, loan information, shipping details, shipping costs, capture payment information for any additional amount such as buy-up, taxes, subtotal and total) and can send checkout confirmation back to store app 110 on computing device 105. Finally store app 110 can receive (334) and cause computing device 105 to display the checkout confirmation, thus, indicating that the transaction is completed.

FIGS. 4A-4H illustrate example preparatory-transaction pages presented by store app 110 on a display of computing device 105 for conducting a preparatory transaction in accordance with some embodiments of the present invention. It will be appreciated by those of ordinary skill in the art that more or less interfaces can be displayed that display more, less, or different options. Additionally, while the figures addressed herein reflect a preparatory transaction to prepare to purchase a new iPhone, this is for example only, and the present technology applies to any transactions where a preparatory transaction would be desirable.

FIG. 4A illustrates an example “discover” page 405 presented by store app 110. “Discover” page 405 is shown with notification 402 announcing that a new iPhone will be available soon, and encourages a user of computing device 105 to engage in a preparatory transaction by selecting one of user selectable options (e.g. link, button, etc.) 406 and 408.

FIG. 4B illustrates an example “Get Ready” page 410 presented by store app 110. “Get Ready” page 410 presents introductory message 412 that explains a preparatory transaction to the user. Introductory message 412 explains that the user account is eligible to upgrade to a new iPhone and that by taking advantage of the preparatory transaction, the user account can have a more efficient check out when the iPhone goes on sale. “Get Ready” page 410 also shows the steps 414 involved in a preparatory transaction and the progress 414 the user account has made in the process. The first step, “confirm your upgrade eligibility” has already been completed. “Get Ready” page 410 also provides selectable button 416 to continue with the preparatory transaction.

In some embodiments, the user account logged into store app 110, may have multiple iPhones available to be upgrade in a preparatory transaction. In such embodiments “Get Ready” page 410 can also show a listing of all phones available to upgrade. However in FIG. 4B “Get Ready” page 410 does not indicate more than one phone available to upgrade, but provides an option 418 to check eligibility for upgrades of other iPhones.

FIG. 4C illustrates an example “Model” page 415 presented by store app 110. “Model” page 415 provides selectable options 422 to the user to select a new iPhone model. After a user operates computing device 105 to choose the desired iPhone model, store app 110 can present additional pages to allow the user to select additional options for the new iPhone.

For example FIG. 4D illustrates an example “Capacity” page 420 that provides selectable options 426 to the user to choose the capacity of the iPhone being ordered. Additionally “Capacity” page 420 also includes a breadcrumb 424 indicating to the user previously selected options. In FIG. 4D breadcrumb 424 shows that the user has selected a 4.7 inch new iPhone to be used on carrier: Verizon, and the new iPhone will be in the color: silver. In some embodiments, breadcrumb 424 is a selectable option that when selected will return store app 110 to displaying a previous page.

FIG. 4E illustrates and example “Preapproval” page 425 presented by store app 110. “Preapproval” page 425 can present an instructional message 428 informing the user of computing device 105 that the preparatory transaction will take the steps to get the user preapproved for an upgrade program loan. “Preapproval” page 425 includes Social Security number field 432 for receiving the user's Social Security number. As will be made more clear with respect to FIG. 4F, the user's Social Security number is used to look up any existing upgrade program loans associated with the user's Social Security number. It will be appreciated by persons of ordinary skill in the art that a Social Security number is just one mechanism by which to identify a customer and a past loan application, and that any identifying information, or combinations of information (whether the information identifies the user, the computing device, the loan, etc.), can be used to identify a user or loan application.

“Preapproval” page 425 also provides informational message 429 that explains to the user how the upgrade program will work to allow the user to purchase their new iPhone. Informational message 429 explains that once the user's iPhone ships, the payments on their current loan will be paused but payments on their new loan will begin. The user will be required to trade in their existing iPhone before the existing loan will be closed out.

“Preapproval” page 425 also includes a selectable “Submit” button 431 that when selected affirms the user's intention to re-enroll in the upgrade program.

FIG. 4F illustrates another example “Preapproval” page, “Preapproval” page 430. “Preapproval” page 430 presents a loan form requesting information needed to evaluate the user's loan application. As noted above, “preapproval” page 430 includes message 436 explaining that the user's Social Security number entered on the previous preapproval” page 425 was used to auto fill the loan application form displayed on “preapprovals” page 430. As illustrated in FIG. 4F, fields 433 have been automatically filled in, but some fields such as fields 432 still require the user to input the information into the form using computing device 105. After all required fields have been filled in, the user can select selectable submit button 431 to advance the preparatory session.

FIG. 4G illustrates an example “Your Status” page 435. “Your Status” page 435 illustrates checklist 438 showing that the user has successfully confirmed their upgrade ability, chose their preferred iPhone, confirmed their carrier and have been preapproved for the upgrade program. Additionally “Your Status” page 435 displays message 434 informing the user how to take advantage of the preparatory session by completing the transaction during a transaction session that will be available starting on October 27. If the user desires, the user can select selectable calendar option 437, which when selected can create a calendar reminder to remind the user when the transaction session will be available.

“Your Status” page 435 additionally presents message 442 that informs the user that their preapproval has a limited life, and that the preapproval will expire several days after the preorder period ends (when the transaction session is available).

FIG. 4G also illustrates selectable option 444 that when selected initiates a new preparatory session to pre-approve another iPhone for upgrade.

FIG. 4H illustrates an example “Upgrade Program” page 440. “Upgrade Program” page 440 provides confirmatory information showing that the user is preapproved for their new iPhone and informs the user of the old iPhone that is being upgraded and traded in.

FIGS. 5A, 5B, and 5C illustrate example user interfaces presented by store app 110 on a display of computing device 105 for conducting a transaction session in accordance with some embodiments of the present invention. It will be appreciated by those of ordinary skill in the art that more or less interfaces can be displayed that display more, less, or, different options. Additionally, while the figures addressed herein reflect a transaction session to complete a purchase of the new iPhone, this is for example only, and the present technology applies to any transactions where a preparatory session and subsequent transaction session would be desirable.

FIG. 5A illustrates an example “Discover” page 505 that presents notification 502 informing the user that it is now possible to purchase the new iPhone, and that the user can complete their upgrade which they began in a preparatory session as described above. User can operate computing device 105 to select notification 502, which can launch example “Pre-order” page 510 as illustrated in FIG. 5B. As illustrated in FIG. 5B, the details from the preparatory session are displayed. For example, details 504 regarding the selected new iPhone and the selected options are displayed along with selectable “check out” option 508. When the user selects selectable “check out” option 508 by operating computing device 105, the transaction session can complete the purchase of the iPhone. However, if the user would like to make changes to the selected iPhone or options, the user can to choose a different model and configure a new iPhone. In some embodiments, the preapproval of the upgrade program loan can still apply even when the user changes to a different model.

FIG. 5C illustrates an example confirmation page 515. Confirmation page 515 provides details regarding the now purchased iPhone including information regarding when the user can pick up the item. Additionally confirmation page 515 also informs the user to expect a receipt and trade-in instructions in their email.

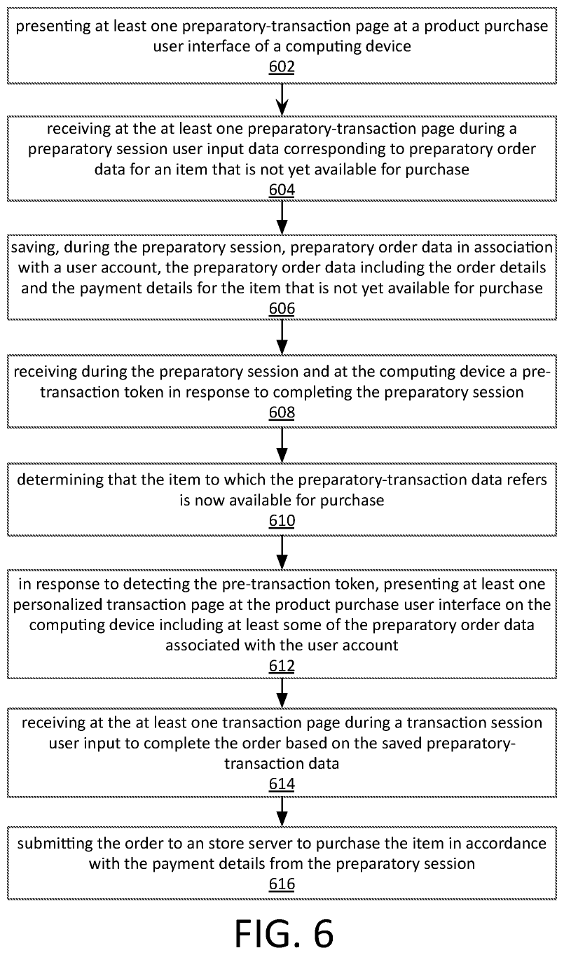

FIG. 6 illustrates an example method for carrying out a transaction on a computing device wherein the transaction takes place in two sessions—a preparatory session, and a transaction session. A user can operate the computing device to open an application or website (herein after referred to as “application”) that can be in communication with a store server.

At a first time, the application can present (602) at least one preparatory-transaction page at a product purchase user interface of a computing device. The user then can operate the mobile device and the application can receive (604) at the at least one preparatory-transaction page, during a preparatory session, user input data corresponding to preparatory order data for an item that is not yet available for purchase from the store server. For example, the user can operate the computing device to provide inputs into the preparatory-transaction page pertaining to a future purchase of the item that is not yet available for purchase from the store server. The inputs can be received as preparatory order data.

The computing device can save (606) during the preparatory session, the preparatory order data in association with a user account associated with the user operating the computing device. The preparatory order data can include the order details and the payment details for the item that is not yet available for purchase.

The computing device can receive (608) a pre-transaction token in response to completing the preparatory session, or can receive the pre-transaction token and updates to the token at one or more times throughout the preparatory session. In some embodiments, the pre-transaction token can be a cookie stored on the computing device that alerts the application of the existence of data associated with a preparatory session. In some embodiments, the pre-transaction token can be session data stored on the computing device or at the store server containing or referring to the preparatory order data.

At a second time, subsequent to the first time, the user can operate the computing device to interact with the application. At that time, the application (610) can determine that the item to which the preparatory-transaction data refers is now available for purchase.

In some embodiments, the user comes back to interact with the application at the second time when the computing device receives a notification from the store server that is issued via a notification service. The notification (text, alert, email etc.) can alert both the user via a message and the application that the item is now available to purchase.

In some embodiments, the user comes back to interact with the application at the second time when the user is reminded by a calendar reminder.

While the user is interacting with the application on the computing device, the application can detect the pre-transaction token, and present (612) at least one personalized transaction page at the product purchase user interface on the computing device including at least some of the preparatory order data associated with the user account. In some embodiments, in addition to the preparatory-transaction data, the at least one personalized transaction page can include data retrieved from other resources associated with the user account or from third parties such as a bank loan service.

The application can receive (614) at the at least one transaction page during a transaction session user input to complete the order based on the saved preparatory-transaction data. Thereafter, the application can submit (616) the order to a store server to purchase the item in accordance with the payment details from the preparatory session.

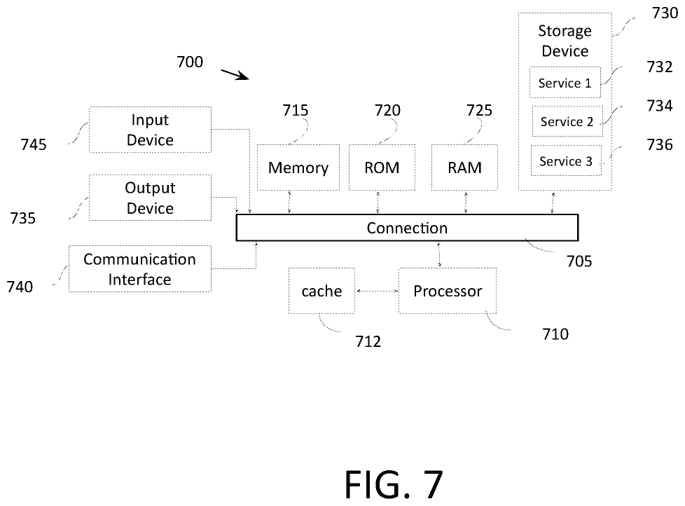

FIG. 7 shows an example of computing system 700, which can be for example any computing device making up computing device 105 or store server 120, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some embodiments, computing system 700 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read only memory (ROM) 720 and random access memory (RAM) 725 to processor 710. Computing system 700 can include a cache of high-speed memory 712 connected directly with, in close proximity to, or integrated as part of processor 710.

Processor 710 can include any general purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. There is no restriction on operating on any particular hardware arrangement and therefore the basic features here may easily be substituted for improved hardware or firmware arrangements as they are developed.

Storage device 730 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 730 can include software services, servers, services, etc., that when the code that defines such software is executed by the processor 710, it causes the system to perform a function. In some embodiments, a hardware service that performs a particular function can include the software component stored in a computer-readable medium in connection with the necessary hardware components, such as processor 710, connection 705, output device 735, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

While the figures and descriptions addressed herein reflect a preparatory transaction to prepare to purchase a new iPhone, this is for example only, and the present technology applies to any transactions where a preparatory transaction would be desirable. Likewise, while the present technology was described with respect to preparatory transactions including a loan or an upgrade program, this too was for example only. The present technology should not be considered to be limited by the type or nature of the preparatory session or of the transaction session.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
presenting at least one preparatory-transaction page at a product purchase user interface of a computing device,
receiving at the at least one preparatory-transaction page during a preparatory session user input data corresponding to preparatory order data for an item that is not yet available for purchase;
saving, during the preparatory session, preparatory order data in association with a user account, the preparatory order data including the order details and the payment details for the item that is not yet available for purchase;
receiving during the preparatory session and at the computing device a pre-transaction token in response to completing the preparatory session;
determining that the item to which the preparatory-transaction data refers is now available for purchase;
in response to detecting the pre-transaction token, presenting at least one personalized transaction page at the product purchase user interface on the computing device including at least some of the preparatory order data associated with the user account;
receiving at the at least one transaction page during a transaction session user input to complete the order based on the saved preparatory-transaction data; and
submitting the order to a store server to purchase the item in accordance with the payment details from the preparatory transaction.

2. The method of claim 1, wherein the payment details include a loan application for a loan for a purchase price of the item.

3. The method of claim 2, comprising:
during the preparatory session, determining that the user account has an existing loan associated with it;
requesting loan details pertaining to the existing loan; and
pre-populating the loan application with the loan details from the existing loan on the preparatory-transaction page.

4. The method of claim 2, comprising:
during the preparatory session, determining that the computing device is eligible for an upgrade consistent with a loan term for an existing loan;
providing, on the preparatory-transaction page, the loan application for the loan for the purchase price of the item with details from the existing loan pre-populated in the loan application.

5. The method of claim 2, comprising:
during the preparatory session, determining that the user account was used to purchase a second computing device, the second computing device being associated with a second user account as the primary user account;
determining that the second computing device is eligible for an upgrade consistent with a loan term for an existing loan associated with the user account;
providing the loan application for the loan for the purchase price of the item having details from the existing loan pre-populated in the loan application, wherein the item is an upgraded second computing device.

6. The method of claim 1, wherein the item that is not yet available to purchase is a second computing device, the method comprising:
associating a second user account as a primary user account for the second computing device, wherein the second user account receives a pre-transaction token from the e-commerce server indicating that the preparatory-transaction is associated with the user account and the second user account.

7. The method of claim 1, wherein the save the preparatory order data comprises sending the preparatory order data for storage at the store server, and wherein the receiving the pre-transaction token is in response to sending the preparatory order data for storage at the store server.

8. The method of claim 7, comprising
detecting the stored pre-transaction token indicating that the preparatory-transaction is associated with the user account; and
the determining that the item to which the preparatory-transaction refers is now available for purchase is performed in response to the detecting the stored pre-transaction token.

9. A computing system comprising at least one storage device having instructions stored thereon, the instructions effective to cause the computing system to:
receive a request to initiate a preparatory session in association with a user account to complete order details and payment details for an item that is not yet available to purchase;
receive preparatory-transaction data describing the item that is not yet available to purchase and payment details;
store the preparatory-transaction data in association with the user account;
receive a request to initiate a transaction session to complete the order of the stored preparatory-transaction data for the item;
determine that the item to which the preparatory-transaction data refers is now available for purchase; and
complete a purchase of the item in accordance with the payment details from the preparatory-transaction.

10. The computing system of claim 9 wherein the payment details include a loan application for a loan for a purchase price of the item.

11. The computing system of claim 9, wherein the instructions are effective to cause the computing system to:
after the receiving of the request to initiate the preparatory session, determine that the user account has an existing loan associated with it;
request loan details pertaining to the existing loan from a bank holding the loan;
send the loan details from the existing loan to a user device to be used to populate a new loan application.

12. The computing system of claim 11, wherein the instructions are effective to cause the computing system to:
determine that the user account is eligible for an upgrade consistent with a loan term for the existing loan.

13. The computing system of claim 10, wherein the instructions are effective to cause the computing system to:
determine that the user account was used to purchase a second computing device, the second computing device being associated with a second user account as the primary user account;
determine that the second computing device is eligible for an upgrade consistent with a loan term for an existing loan associated with the user account;
send loan details from the existing loan to a user device to be used to populate a new loan application to be used to pay for the item, wherein the item is an upgraded second computing device.

14. The computing system of claim 9, wherein the item that is not yet available to purchase is a second computing device, wherein the instructions are effective to cause the computing system to:
associate a second user account as a primary user account for the second computing device; and
store an indication of the purchase of the second computing device in association with the user account and the second user account.

15. A non-transitory computing-device readable medium comprising instructions stored thereon that when executed are effective to cause a computing device to:
conduct a preparatory session to complete order details and payment details for an item that is not yet available to purchase and to save a preparatory-transaction for the item that is not yet available to purchase in association with a user account, the instructions to conduct the preparatory session cause the computing device to:
present a preparatory-transaction page on the computing device;
receive user inputs on the preparatory-transaction page using a user interface of the computing device effective to select the item that is not yet available to purchase and to receive the payment details;
send data regarding the selection of the item that is not yet available to purchase and the payment details to a e-commerce server;
receive a confirmation from the e-commerce server that the preparatory-transaction for the item that is not yet available to purchase is stored in association with the user account;
receive a cookie from the e-commerce server indicating that the preparatory-transaction is associated with the user account;
store the cookie indicating that the preparatory-transaction is associated with the user account on the computing device;
conduct a transaction session to complete the order of the stored preparatory-transaction for the item that is not yet available to purchase that is stored in association with a user account, the instructions to conduct the transaction session cause the computing device to:
detect the stored cookie indicating that the preparatory-transaction is associated with the user account;
determine that the item to which the preparatory-transaction refers is now available for purchase:
present a transaction page on the computing device, the transaction page including completed order and payment details from the preparatory-transaction, and an option to complete the transaction according to the completed order and payment details from the preparatory-transaction;
receive a selection of the option to complete the transaction; and
send a request to the e-commerce server to purchase the item in accordance with the payment details from the preparatory-transaction.

16. The non-transitory computing-device readable medium of claim 15, wherein the payment details include a loan application for a loan for a purchase price of the item.

17. The non-transitory computing-device readable medium of claim 16, wherein the instructions to conduct the preparatory session cause the computing device to:
determine that the user account has an existing loan associated with it;
request loan details pertaining to the existing loan;
pre-populate the loan application with the loan details from the existing loan.

18. The non-transitory computing-device readable medium of claim 16, wherein the instructions to conduct the preparatory session cause the computing device to:
determine that the computing device is eligible for an upgrade consistent with a loan term for an existing loan;
provide the loan application for the loan for the purchase price of the item having details from the existing loan pre-populated in the loan application.

19. The non-transitory computing-device readable medium of claim 16, wherein the instructions to conduct the preparatory session cause the computing device to:
determine that the user account was used to purchase a second computing device, the second computing device being associated with a second user account as the primary user account;
determine that the second computing device is eligible for an upgrade consistent with a loan term for an existing loan associated with the user account;
provide the loan application for the loan for the purchase price of the item having details from the existing loan pre-populated in the loan application, wherein the item is an upgraded second computing device.

20. The non-transitory computing-device readable medium of claim 15, wherein the item that is not yet available to purchase is a second computing device, the instructions to conduct the preparatory session cause the computing device to:
associate a second user account as a primary user account for the second computing device, wherein the second user account receives a copy of the cookie from the e-commerce server indicating that the preparatory-transaction is associated with the user account and the second user account.
